(19) United States
(12) Patent Application Publication
(10) Pub. No.: US 2023/0306840 A1
(43) Pub. Date: Sep. 28, 2023

(54) TRAFFIC MONITORING TERMINAL AND TRAFFIC MONITORING SYSTEM

(71) Applicant: Spreadtrum Communications (Shenzhen), Shenzhen, Guangdong (CN)

(72) Inventor: Chuan HE, Guangdong (CN)

(21) Appl. No.: 18/020,061

(22) PCT Filed: Aug. 5, 2021
(86) PCT No.: PCT/CN2021/110755

§ 371 Date: Feb. 6, 2023

(30) Foreign Application Priority Data
Aug. 6, 2020 (CN) 202010781417.1

(51) Int. Cl. G08G 1/04; G08G 1/08; G06V 20/54; G08G 1/01

(52) U.S. Cl. CPC G08G 1/04; G08G 1/08; G06V 20/54; H04N 23/70; G08G 1/0125

(57) ABSTRACT

A traffic monitoring terminal and a traffic monitoring system are provided. The traffic monitoring terminal includes a camera module configured to acquire a traffic image of an intersection and a control module configured to acquire a number of vehicles waiting at the intersection based on the traffic image.

### CROSS-REFERENCE TO RELATED APPLICATIONS

The present application claims priority to Chinese Patent Application No. 202010781417.1, filed on Aug. 6, 2020, the content of which is incorporated herein by reference in its entirety.

### TECHNICAL FIELD

The present disclosure belongs to the technical field of traffic monitoring, and in particular relates to a traffic monitoring terminal and a traffic monitoring system.

### BACKGROUND

In the traffic monitoring terminals in the related art, some systems are installed on smart phones in the form of application (APP) and applet, and users participate in traffic management and supervision through their own mobile phones. This solution is convenient for collecting evidence of illegal parking and collision accidents occurring on urban and rural roads, but it is unable to monitor violations that occur during vehicle running and need to be proved by multiple images. The reason is very simple. It is hard for a human being on foot to exceed the running speed of the vehicle to capture violation images. Illegal parking, illegal crossing and other violations that do not require rescue on expressway sections are often clear for drivers on the same section, but not for passers-by. However, it is undoubtedly risky for drivers to operate their mobile phones to record the violation. The event data recorder (EDR) can record the violation, but because it is troublesome to access the video of the EDR, the driver may choose to acquiesce in the violation. Therefore, although the solution in the prior art has the advantage of public participation, it cannot achieve efficient traffic management.

In addition to the above disadvantage, the electronic police (e-police) system widely used at present has the following disadvantages.
1. The e-police system is not flexible enough for construction roads and peak roads, and an advanced e-police and traffic light system needs to be connected with the smart city system.
2. The e-police system has a limited function, and it can only monitor violations of a single nature.
3. It is difficult for the e-police system to assist medium-sized communities, industrial parks, industrial ecological parks and other special places in traffic law enforcement. When large-scale activities such as fire drills are held, the e-police system needs to be manually reconfigured to avoid false alarms.
4. The e-police system does not have such features as automatic networking and block negotiation.

### SUMMARY

In order to solve the technical problem of insufficient accuracy of traffic monitoring in the related art, the present disclosure provides a traffic monitoring terminal and traffic monitoring system.

The present disclosure solves the technical problem through the following technical solutions.

The present disclosure provides a traffic monitoring terminal including a camera module and a control module. The camera module is configured to acquire a traffic image of an intersection, and the control module is configured to acquire a number of vehicles waiting at the intersection based on the traffic image.

The technical solution can accurately acquire the traffic condition by identifying the number of vehicles based on traffic image, thus improving the accuracy of traffic monitoring.

In some embodiments, the traffic monitoring terminal further includes an infrared module configured to acquire an infrared image of a pedestrian waiting zone, and the control module is configured to acquire a first proportion defined by a proportion of a region corresponding to a human body temperature in the infrared image to the infrared image, and to acquire a first area defined by a product of a road area corresponding to the infrared image and the first proportion.

The technical solution acquires the infrared image of the pedestrian waiting zone and the proportion of the region corresponding to the human body temperature in the infrared image to the infrared image, so as to acquire the number of the pedestrians in the pedestrian waiting zone. It can provide more traffic monitoring parameters to improve the accuracy of traffic monitoring.

In some embodiments, the control module is further configured to acquire a number of pedestrians in the pedestrian waiting zone based on the first area.

The technical solution acquires the number of the pedestrians in the pedestrian waiting zone by analyzing the infrared image of the pedestrian waiting zone, so as to provide more traffic monitoring parameters to improve the accuracy of traffic monitoring.

In some embodiments, the control module is further configured to acquire a first pixel number that is the number of pixels located in the region corresponding to the human body temperature in the infrared image, and to acquire the first proportion based on a ratio of the first pixel number to a total number of pixels in the infrared image.

The technical solution acquires the proportion of the region corresponding to the human body temperature in the infrared image by analyzing the pixels in the infrared image, so as to acquire high accuracy.

In some embodiments, the traffic monitoring terminal further includes a positioning module configured to acquire geographic location information.

The technical solution acquires the geographic location information of the traffic monitoring terminal through the positioning module, so as to timely provide geographic location of the monitored traffic condition. The technical solution can call the corresponding traffic monitoring terminal for the desired monitoring location, which improves the flexibility of monitoring. The positioning module includes a global positioning system (GPS) module or a Beidou navigation module.

In some embodiments, the traffic monitoring terminal further includes a networking module configured to network the traffic monitoring terminal with an object traffic monitoring terminal based on the geographic location information, and the object traffic monitoring terminal is networked as another traffic monitoring terminal within a preset distance range.

The technical solution can realize the autonomic networking of multiple traffic monitoring terminals within a preset range based on the networking module, so as to realize the coordination and complementarity between the multiple traffic monitoring terminals, thus increasing the traffic monitoring modes and improving the flexibility of monitoring. The networking module includes an Internet of Things (IoT) networking module, and the IoT networking module includes a wireless fidelity (Wi-Fi) module.

In some embodiments, the control module is further configured to transmit an assistance request signal to the object traffic monitoring terminal through the networking module, and the assistance request signal is configured to request the object traffic monitoring terminal to acquire a traffic image.

In the technical solution, a current traffic monitoring terminal can transmit an assistance request signal to another networked traffic monitoring terminal after identifying a vehicle violation. The another networked traffic monitoring terminal acquires a monitoring image based on the assistance request signal so as to comprehensively monitor the traffic condition from multiple angles and provide more reference information for vehicle violation identification.

In some embodiments, the control module is further configured to receive the assistance request signal sent by the object traffic monitoring terminal through the networking module; and the control module is further configured to control the camera module to acquire the traffic image based on the assistance request signal.

In the technical solution, when the current traffic monitoring terminal identifies a vehicle violation, the current traffic monitoring terminal can transmit an assistance request signal to another networked traffic monitoring terminal. The current traffic monitoring terminal acquires a monitoring image based on the assistance request signal so as to comprehensively monitor the traffic condition from multiple angles and provide more reference information for vehicle violation identification.

In some embodiments, the traffic monitoring terminal further includes a light sensing module configured to acquire an intensity of ambient light, and the control module is further configured to adjust an exposure mode of the camera module based on the intensity of the ambient light.

In the technical solution, when the intensity of the ambient light is smaller than a preset intensity value, the control module activates a high-exposure mode of the camera module. When the intensity of the ambient light is not smaller than the preset intensity value, the control module deactivates the high-exposure mode of the camera module and only activates a normal-exposure mode. The exposure mode of the camera module is adjusted based on the intensity of the ambient light so as to acquire a clear image.

In some embodiments, the control module is further configured to adjust an alternating time of traffic lights at the intersection based on the number of the vehicles waiting at the intersection.

In the technical solution, for a driving direction where there are obviously many waiting vehicles and the traffic is busy and easy to jam, a longer traffic time (i.e. a longer green light time) and a shorter waiting time (i.e. a shorter red light time) are set. For a driving direction with fewer waiting vehicles and small traffic pressure, a longer waiting time (i.e. longer red light time) and a shorter traffic time (i.e. shorter green light time) are set. In view of the above, the present design can effectively improve the efficiency of vehicle traffic and reduce traffic congestion.

In some embodiments, the control module is further configured to adjust an alternating time of traffic lights at the intersection based on the number of the pedestrians in the pedestrian waiting zone.

In the technical solution, the alternating time of the traffic lights at the intersection is adjusted based on the number of the pedestrians in the pedestrian waiting zone, so as to improve the efficiency of pedestrian traffic and improve the flexibility of traffic monitoring.

In some embodiments, the traffic monitoring terminal further includes a non-contact communication module configured to communicate with an external device in a non-contact manner.

In the technical solution, monitoring data can be acquired by an external non-management user through the non-contact communication module, which improves the convenience of monitoring. The non-contact communication module includes a near field communication (NFC) module.

In some embodiments, the traffic monitoring terminal further includes a light-emitting diode (LED) interface configured to be connected to an external LED display device.

In the technical solution, the LED interface is connected to the external LED display device, and can simulate the traffic light configuration. The LED display device can display speed limit information, safety reminder information and other necessary information of the intersection.

In some embodiments, the traffic monitoring terminal further includes a barometer configured to acquire an ambient pressure value.

In some embodiments, the control module is further configured to acquire an installation height of the traffic monitoring terminal based on the ambient pressure value.

In some embodiments, the control module is further configured to adjust an exposure mode of the camera module based on current time information.

The present disclosure further provides a traffic monitoring system including at least two traffic monitoring terminals, each of which is the traffic monitoring terminal according to the present disclosure.

In some embodiments, the traffic monitoring system further includes a cloud platform connected to and communicated with the at least two traffic monitoring terminals, the cloud platform is configured to acquire data from a target traffic monitoring terminal based on a target geographic location, and the target traffic monitoring terminal is a traffic monitoring terminal with a distance from the target geographic location smaller than a preset distance value.

In the technical solution, a user can interact with the cloud platform through a mobile terminal, and acquire the data of the target traffic monitoring terminal by requesting with the target geographic location through the cloud platform.

The present disclosure has the following effects. The technical solution of the present disclosure improves the accuracy of traffic monitoring, enriches the monitoring modes, and realizes the sharing and assistance of monitoring information based on the automatic networking function, thus improving the comprehensiveness of traffic monitoring.

### BRIEF DESCRIPTION OF DRAWINGS

FIG. 1 is a structural diagram of a traffic monitoring terminal according to Embodiment 1 of the present disclosure;

FIG. 2 is a structural diagram of a traffic monitoring terminal according to Embodiment 2 of the present disclosure;

FIG. 3 is a structural diagram of a traffic monitoring terminal according to Embodiment 3 of the present disclosure;

FIG. 4 is a structural diagram of a traffic monitoring system according to Embodiment 4 of the present disclosure; and

FIG. 5 is a schematic diagram of configuration of the traffic monitoring system according to Embodiment 4 of the present disclosure.

### DESCRIPTION OF EMBODIMENTS

The present disclosure is further described below with reference to the embodiments, but the present disclosure is not limited to the scope of the described embodiments.

### Embodiment 1

This embodiment provides a traffic monitoring terminal. The traffic monitoring terminal is provided at an intersection of traffic roads to monitor a traffic condition at the intersection.

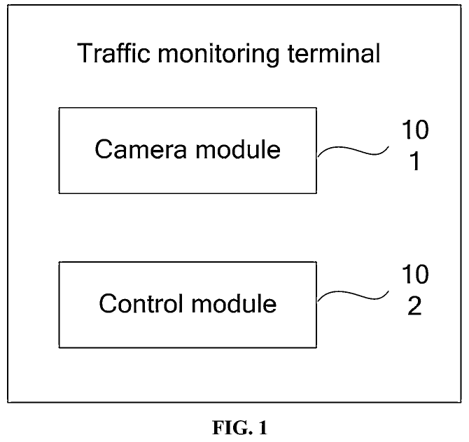

Referring to FIG. 1, the traffic monitoring terminal includes a camera module 101 and a control module 102. The camera module 101 is configured to acquire a traffic image of the intersection. The control module 102 is configured to acquire a number of vehicles waiting at the intersection based on the traffic image.

The camera module 101 is configured to acquire a traffic image of the traffic condition at the intersection. The control module 102 is configured to acquire a number of vehicles waiting at the intersection based on the traffic image. In some embodiments, the control module 102 identifies the vehicles in the traffic image based on an image identification algorithm and counts the number of the vehicles to acquire the number of vehicles waiting to pass. In other embodiments, the control module 102 identifies the vehicles in the image as rectangular blocks based on an image processing algorithm and the image identification algorithm, and determines the number of the vehicles in the image based on the number of the rectangular blocks in the image.

In an embodiment, the control module 102 is configured to adjust an alternating time of traffic lights at the intersection based on the number of the vehicles waiting at the intersection. For example, for a driving direction where there are obviously many waiting vehicles and the traffic is busy and easy to jam, a longer traffic time (i.e. a longer green light time) and a shorter waiting time (i.e. a shorter red light time) are set. For a driving direction with fewer waiting vehicles and less traffic pressure, a longer waiting time (i.e. longer red light time) and a shorter traffic time (i.e. shorter green light time) are set. In view of the above, the design can effectively improve the efficiency of vehicle traffic and reduce traffic congestion.

The control module 102 is implemented by a central processing unit (CPU).

In other embodiments, the control module 102 is configured to acquire current time information, and adjust an exposure mode of the camera module 101 based on the current time information. If the current time belongs to a night stage, the control module 102 turns on a high-exposure mode of the camera module 101. If the current time belongs to a daytime stage, the control module 102 turns off the high-exposure mode of the camera module 101, and only turns on a normal-exposure mode. The exposure mode of the camera module 101 is adjusted to adaptively acquire a clear image.

In this embodiment, the traffic monitoring terminal can accurately acquire the traffic condition by identifying the number of vehicles based on traffic image, thus improving the accuracy of traffic monitoring.

The traffic monitoring terminal of this embodiment can be provided in special sections such as a construction road section, a newly incorporated strictly-managed road section, and a road section around a school. The traffic monitoring terminal can be flexibly installed and disassembled due to its convenience.

### Embodiment 2

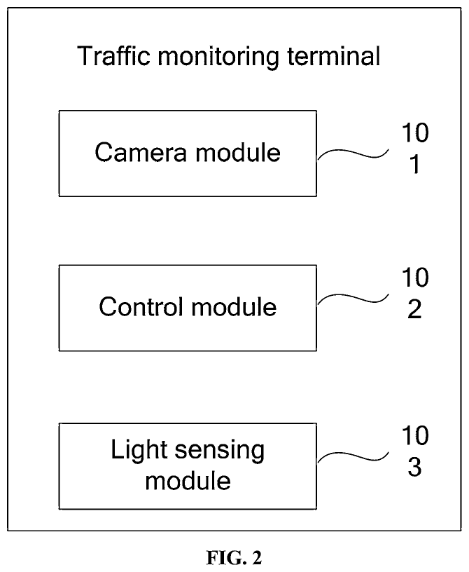

This embodiment provides a traffic monitoring terminal on the basis of Embodiment 1. Referring to FIG. 2, the traffic monitoring terminal includes a light sensing module 103. The light sensing module 103 is configured to acquire an intensity of ambient light, and the control module 102 is further configured to adjust the exposure mode of the camera module 101 based on the intensity of the ambient light. The control module 102 is configured to turn on or turn off the high-exposure mode of the camera module 101 based on the intensity of the ambient light. When the intensity of the ambient light is smaller than a preset intensity value, the control module 102 turns on the high-exposure mode of the camera module 101. When the intensity of the ambient light is not smaller than the preset intensity value, the control module 102 turns off the high-exposure mode of the camera module 101 and only turns on the normal-exposure mode. The exposure mode of the camera module 101 is adaptively adjusted based on the intensity of the ambient light so as to acquire a clear image. The preset intensity value can be set reasonably as required.

### Embodiment 3

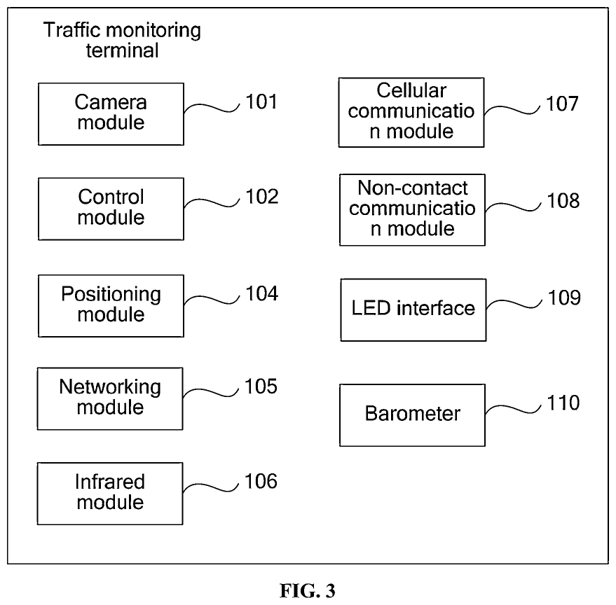

This embodiment provides a traffic monitoring terminal on the basis of Embodiment 1 or 2. Referring to FIG. 3, in this embodiment, the traffic monitoring terminal includes a positioning module 104 configured to acquire geographic location information. The positioning module 104 acquires the geographic location information of the traffic monitoring terminal through the positioning module, so as to timely provide geographic location of the monitored traffic condition. The technical solution can call the corresponding traffic monitoring terminal for the desired monitoring location, which improves the flexibility of monitoring. The positioning module 104 includes a global positioning system (GPS) module or a Beidou navigation module.

In this embodiment, the traffic monitoring terminal includes a networking module 105. The networking module 105 is configured to network the traffic monitoring terminal with an object traffic monitoring terminal based on the geographic location information, and the object traffic monitoring terminal is networked as another traffic monitoring terminal within a preset distance range. When multiple traffic monitoring terminals are arranged at the same intersection, the distances between these traffic monitoring terminals are within a preset distance range. After these traffic monitoring terminals are started, the networking module 105 transmits a networking request signal to an external device and receives an external networking request signal. When one traffic monitoring terminal successfully communicates with another object traffic monitoring terminal through the networking module 105, networking is completed.

The networking module 105 can realize the autonomic networking between the multiple traffic monitoring terminals within a preset range, so as to realize the coordination and complementarity between the multiple traffic monitoring terminals, thus increasing the traffic monitoring modes and improving the flexibility of monitoring. The networking module 105 includes an Internet of Things (IoT) networking module 105. The IoT networking module 105 includes a wireless fidelity (Wi-Fi) module. The preset distance range can be set reasonably.

After the multiple traffic monitoring terminals are networked successfully, the multiple traffic monitoring terminals can share data and assist each other in acquiring monitoring information. Any one of the traffic monitoring terminals can share relevant images it acquires with another networked traffic monitoring terminal. Any one of the traffic monitoring terminals can also acquire, based on license plate label information in the acquired relevant image, an image with the license plate label information from another traffic monitoring terminal, and form the acquired image into a long image to generate a violation information table.

In some embodiments, when the traffic monitoring terminal identifies a vehicle violation, the control module 102 of the traffic monitoring terminal transmits an assistance request signal to the object traffic monitoring terminal through the networking module 105, so as to request the object traffic monitoring terminal to acquire a traffic image. After receiving the assistance request signal, another networked traffic monitoring terminal captures an image based on its own shooting angle so as to acquire traffic images from more angles. The design can provide more evidence or reference information for vehicle violation identification and improve the accuracy of traffic monitoring.

In an embodiment, the traffic monitoring terminal includes an infrared module 106 configured to acquire an infrared image of a pedestrian waiting zone. The control module 102 is configured to acquire a first proportion defined by a proportion of a region corresponding to a human body temperature in the infrared image to the infrared image, and to acquire a first area defined by a product of a road area corresponding to the infrared image and the first proportion. The design acquires the infrared image of the pedestrian waiting zone and the proportion of the region corresponding to the human body temperature in the infrared image, so as to acquire the number of the pedestrians in the pedestrian waiting zone. It can provide more traffic monitoring parameters to improve the accuracy of traffic monitoring.

After the setting of the traffic monitoring terminal is completed, the road area corresponding to the image captured by the infrared module 106 is known. The infrared image characterizes corresponding temperatures through different colors. The control module 102 acquires a color block of the infrared image corresponding to the human body temperature based on the image identification algorithm, and acquires a corresponding target area of the color block in the infrared image. The control module 102 acquires a first proportion based on a ratio of the target area to an area of the infrared image, that is, a proportion of a region corresponding to the human body temperature in the infrared image to the infrared image. The control module 102 acquires an area occupied by pedestrians based on a product of the first proportion and a road area corresponding to the image taken by the infrared module 106, that is, a first area. The control module 102 also acquires a number of the pedestrians based on the area occupied by the pedestrians. In an embodiment, the control module 102 calculates the number of the pedestrians in the pedestrian waiting zone based on the first area and an empirical value of an area occupied by a single pedestrian. The number of the pedestrians is a ratio of the first area to the empirical value of the area occupied by the single pedestrian.

In other embodiments, the control module 102 acquires a color block corresponding to the human body temperature in the infrared image based on the image identification algorithm, and acquires a corresponding first pixel number of the color block in the infrared image. The control module 102 identifies whether a temperature corresponding to a pixel value of the infrared image belongs to a corresponding human body temperature range. The control module 102 acquires the total number of the pixels in the infrared image based on a preset specification of the infrared image. The control module 102 acquires a first proportion based on a ratio of the first pixel number to a total pixel number of the infrared image, that is, a proportion of the region corresponding to the human body temperature in the infrared image.

The design acquires the proportion of the region corresponding to the human body temperature in the infrared image by analyzing the pixels in the infrared image, so as to acquire high accuracy.

In an embodiment, the control module 102 is configured to adjust an alternating time of traffic lights at the intersection based on the number of the pedestrians waiting at the intersection. The alternating time of the traffic lights at the intersection is adjusted based on the number of the pedestrians in the pedestrian waiting zone, so as to improve the efficiency of pedestrian traffic and improve the flexibility of traffic monitoring.

In some embodiments, based on a real-time video or image of the traffic condition at the intersection acquired by the camera module 101, the control module 102 identifies whether a vehicle is crossing a solid line based on the image identification algorithm. If the control module 102 identifies that a vehicle is crossing a solid line, the control module 102 controls the camera module 101 to capture and save an image. The control module 102 identifies a license plate number based on the image, and generates a license plate number label.

Based on the real-time video or image of the traffic condition at the intersection acquired by the camera module 101, the control module 102 identifies whether the vehicle runs a red light based on the image identification algorithm. If the control module 102 identifies that the vehicle runs a red light based on, the control module 102 controls the camera module 101 to capture and save an image. The control module 102 identifies a license plate number based on the image, and generates a license plate number label.

In some embodiments, there are multiple traffic monitoring terminals arranged at the intersection. The traffic monitoring terminals negotiate to form a temporary traffic light display rule, capture images of illegal vehicles based on the temporary traffic light display rule, save the images, identify license plates, and generate license plate labels.

Based on the violation images, the control module 102 identifies a head of the vehicle based on headlights on both sides of the head, identifies a tail of the vehicle based on colors of taillights on both sides, and generates labels.

Based on the geographic location information acquired by the positioning module 104, the control module 102 adds a location label to the violation image already taken. Based on a capturing time, the control module 102 adds a time information label to the violation image already taken.

The traffic monitoring terminal includes a cellular communication module 107 configured to complete a real-time network communication task including performing a rough base station positioning task and assisting the positioning module 104 in positioning. For a completed violation determination, the control module 102 transmits a violation information table to a cloud platform 3 through the cellular communication module 107. The control module 102 acquires an instruction from the cloud platform 3 through the cellular communication module 107 and executes the instruction. The control module 102 acquires weather information through the cellular communication module 107, intelligently sets a traffic light duration, and realizes intelligent display.

The traffic monitoring terminal includes a non-contact communication module 108. In an embodiment, the non-contact communication module 108 includes a near field communication (NFC) module. In some embodiments, a non-administrator user downloads an original violation video from the traffic monitoring terminal through the NFC module, or downloads a violation image and video information of his/her own vehicle by scanning a code into the cloud platform 3. In other embodiments, the traffic monitoring terminal provides an online query access or application (APP) download link through the NFC module. An administrator user transmits maintenance and debugging instructions to the traffic monitoring terminal through the non-contact communication module 108, or configures the traffic monitoring terminal through the cloud platform 3.

The traffic monitoring terminal includes a light-emitting diode (LED) interface 109 configured to be connected to an external LED display device so as to expand a traffic management function. The LED interface 109 is connected to the external LED display device, and can simulate the traffic light configuration. The LED display device can display speed limit information, safety reminder information and other necessary information of the intersection.

The traffic monitoring terminal includes a barometer 110. The traffic monitoring terminal includes the barometer 110 configured to acquire an ambient pressure value. The control module 102 is configured to acquire an installation height of the traffic monitoring terminal based on the ambient pressure value.

In the embodiment, the traffic monitoring terminal can be implemented based on a mobile terminal or an unmanned aerial vehicle (UAV).

In some embodiments, the traffic monitoring terminal is installed on a movable post. In other embodiments, the traffic monitoring terminal is installed on an electric pole or a street lamp pole to complete a traffic coordination task at an intersection that needs to be assisted in management.

The traffic monitoring terminal can also be provided with multiple camera modules to monitor the road condition and violation. The traffic monitoring terminal can network and communicate with a traffic monitoring terminal at an opposite intersection to complete violation determination.

In the embodiment, the traffic monitoring terminal provides multiple monitoring modes to improve the comprehensiveness and accuracy of traffic monitoring.

In the embodiment, through the camera module 101, the infrared module 106 and a related image recognition function, the traffic monitoring terminal realizes the automatic networking function based on the location information. The traffic monitoring terminal can estimate the number of vehicles and the number of pedestrians at the opposite intersection, and share the information with another networked traffic monitoring terminal in real time. The traffic monitoring terminals at the intersection are networked and coordinated, so as to intelligently allocate the time of traffic light display and reasonably adjust the traffic light display. The traffic monitoring terminal is provided with an external interface, through which the traffic monitoring terminal can be connected with existing public traffic lights or an external LED panel to simulate temporary traffic lights. The LED panel can assist in playing security information.

In the embodiment, the traffic monitoring terminal can delete redundant saved information in time based on its automatic networking and negotiation, to reduce the demand for storage space. Through automatic networking and pedestrian flow monitoring, the traffic monitoring terminal can automatically negotiate the traffic light display solution to relieve the pressure of traffic flow. Through simple algorithm implementation, the traffic monitoring terminal can reduce the demand for system computing capacity and save costs. The traffic monitoring terminal has a multi-network capability, and can share information with another traffic monitoring terminal in real time to improve the traffic maintenance efficiency.

### Embodiment 4

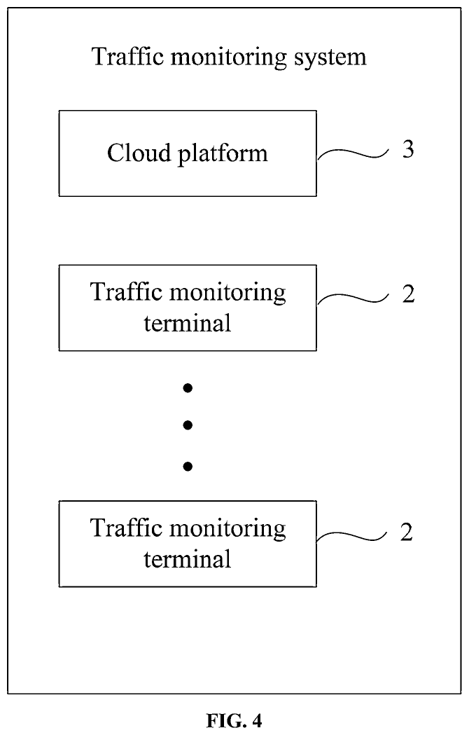

This embodiment provides a traffic monitoring system. Referring to FIG. 4, the traffic monitoring system includes at least two traffic monitoring terminals 2, each of which is the traffic monitoring terminal provided by the present disclosure.

The traffic monitoring system includes a cloud platform 3 connected to and communicated with the at least two traffic monitoring terminals 2.

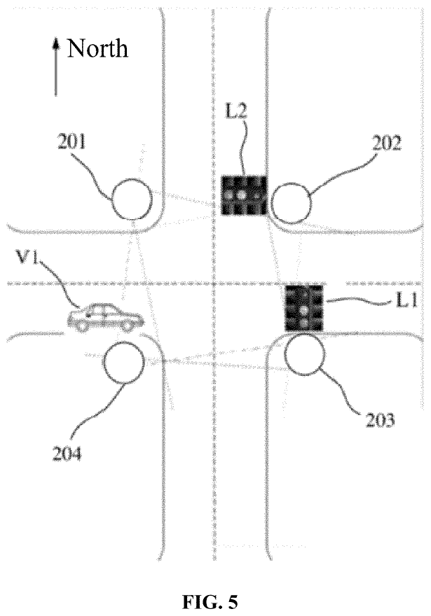

In an embodiment, referring to FIG. 5, the traffic monitoring system includes four traffic monitoring terminals, namely a first traffic monitoring terminal 201, a second traffic monitoring terminal 202, a third traffic monitoring terminal 203, and a fourth traffic monitoring terminal 204. The first traffic monitoring terminal 201, the second traffic monitoring terminal 202, the third traffic monitoring terminal 203 and the fourth traffic monitoring terminal 204 are arranged at an intersection. Exemplarily, a first traffic light L1 and a second traffic light L2 are shown in the figure. After the four traffic monitoring terminals are powered on, they are automatically networked based on geographic location information acquired by the positioning module 104. The camera module 101 may not have a wide angle function (in other embodiments, the camera module 101 has a wide angle function). Installation personnel adjust each of the traffic monitoring terminals to an appropriate angle. In an embodiment, the traffic monitoring terminals each include a 360° rotation module to monitor different directions.

After the setting of the first traffic monitoring terminal 201 is completed, the second traffic monitoring terminal 202, the third traffic monitoring terminal 203 and the fourth traffic monitoring terminal 204 automatically turn 90°, 180° and 270° clockwise respectively based on the positioning direction information shared by the first traffic monitoring terminal 201, to fully cover the road condition at the intersection.

As shown in the figure, a vehicle V1 runs from west to east (the direction shown by the arrow in the figure is north) and turns left to north at the intersection. The fourth traffic monitoring terminal 204 identifies that the first traffic lights L1 turn red, and takes a first image recording the vehicle V1 crossing a stop line. It identifies the license plate and taillights of the vehicle V1 based on the captured first image, marks the incident time, and marks the incident location based on the geographic location information acquired by the positioning module 104.

Based on the violation of the vehicle V1, the fourth traffic monitoring terminal 204 transmits a request signal to other networked monitoring terminals to assist in capturing, and other terminals assist in doing so. The second traffic monitoring terminal 202 captures a second image of the vehicle V1 turning left illegally, identifies the headlights and license plate number of the vehicle from the second image, and marks the time and location of the incident. The vehicle violation can be determined based on the first image. Based on time correlation, the violation fact can be proved based on the second image. In practical application, if the images taken by the second traffic monitoring terminal 202 and the fourth traffic monitoring terminal 204 are not clear enough, the images captured by the first traffic monitoring terminal 201 and the third traffic monitoring terminal 203 can be taken as auxiliary proof, thus forming a complete proof of the violation fact. This method only needs a small ability of image identification.

In an embodiment, multiple traffic monitoring terminals capture images of a vehicle violation from different angles. The traffic monitoring terminals automatically negotiate to save clear and identifiable images and delete redundant images so as to save the storage space.

The intersection is only one of the application scenarios. In the application scenario of a pedestrian crossing on a general straight road, only two traffic monitoring terminals are needed to complete the monitoring task.

For a violation such as a vehicle crossing a solid line, the traffic monitoring terminal identifies the road line, captures the vehicle crossing the solid line, or captures the vehicle crossing a dotted line and changing lanes (small collision accidents often occur in this case).

When the first traffic monitoring terminal 201 identifies that the first traffic lights L1 turn green, it broadcasts the information to other networked traffic monitoring terminals. If the third traffic monitoring terminal 203 identifies that the vehicle V1 stops for a preset time value (for example, 1 minute) when the first traffic lights turn green, the third traffic monitoring terminal 203 determines that the vehicle V1 is broken down or there may be a traffic accident. The driver of the vehicle V1 can connect with the cloud platform 3 through a corresponding APP installed on the mobile terminal of the driver. The driver of the vehicle V1 can transmit help information to the cloud platform 3 through the mobile terminal. The help information includes the geographic location of the vehicle V1. After the cloud platform 3 receives the help information, the cloud platform 3 queries the traffic monitoring terminal corresponding to the geographic location information based on the geographic location information reported by the mobile terminal, and transmits a control instruction to the traffic monitoring terminal. The traffic monitoring terminal takes and transmits a road image to a nearby intelligent law enforcement terminal of traffic police for assistance.

In the embodiment, through the camera module 101, the infrared module 106 and a related image recognition function, the traffic monitoring system realizes the automatic networking function based on the location information. The traffic monitoring system can estimate the number of vehicles and the number of pedestrians at the opposite intersection, and share the information with another networked traffic monitoring terminal in real time. The traffic monitoring terminals at the intersection are networked and coordinated, so as to intelligently allocate the time of traffic light display and reasonably adjust the traffic light display. The traffic monitoring terminal is provided with an external interface, through which the traffic monitoring terminal can be connected with current public traffic lights or an external LED panel to simulate temporary traffic lights. The LED panel can assist in playing security information.

In the embodiment, the traffic monitoring system can delete redundant saved information in time based on its automatic networking and negotiation, to reduce the demand for storage space. Through automatic networking and pedestrian flow monitoring, the traffic monitoring system can automatically negotiate the traffic light display solution to relieve the pressure of traffic flow. Through simple algorithm implementation, the traffic monitoring terminal can reduce the demand for system computing capacity and save costs. The traffic monitoring terminal has a multi-network capability, and can share information with another traffic monitoring terminal in real time to improve the traffic maintenance efficiency.

Although the embodiments of the present disclosure have been described above, those skilled in the art should understand that these are only exemplary embodiments, and the scope of the present disclosure is defined by the appended claims. Those skilled in the art can make various changes or modifications to these examples without departing from the principle of the present disclosure, but all these changes and modifications shall fall within the scope of the present disclosure.

1. A traffic monitoring terminal, comprising a camera device and a central processing unit (CPU), wherein the traffic monitoring terminal is configured to acquire, by the camera device, a traffic image of an intersection and is configured to acquire a number of vehicles waiting at the intersection based on the traffic image.

2. The traffic monitoring terminal according to claim 1,
wherein the traffic monitoring terminal is configured to acquire an infrared image of a pedestrian waiting zone, and
is configured to acquire a first proportion defined by a proportion of a region corresponding to a human body temperature in the infrared image to the infrared image, and to acquire a first area defined by a product of a road area corresponding to the infrared image and the first proportion.

3. The traffic monitoring terminal according to claim 2, wherein the traffic monitoring terminal is further configured to acquire a number of pedestrians in the pedestrian waiting zone based on the first area.

4. The traffic monitoring terminal according to claim 2, wherein the traffic monitoring terminal is further configured to acquire a first pixel number that is a number of pixels located in the region corresponding to the human body temperature in the infrared image, and to acquire the first proportion based on a ratio of the first pixel number to a total number of pixels on the infrared image.

5. The traffic monitoring terminal according to claim 1,
wherein the traffic monitoring terminal is configured to acquire geographic location information.

6. The traffic monitoring terminal according to claim 5,
wherein the traffic monitoring terminal is configured to network the traffic monitoring terminal with an object traffic monitoring terminal based on the geographic location information, wherein the object traffic monitoring terminal is networked as another traffic monitoring terminal within a preset distance range.

7. The traffic monitoring terminal according to claim 6, wherein the traffic monitoring terminal is further configured to transmit an assistance request signal to the object traffic monitoring terminal, wherein the assistance request signal is configured to request the object traffic monitoring terminal to acquire another traffic image.

8. The traffic monitoring terminal according to claim 7, wherein the traffic monitoring terminal is further configured to receive an assistance request signal transmitted by the object traffic monitoring terminal; and
the traffic monitoring terminal is further configured to control the camera device to acquire the traffic image based on the assistance request signal transmitted by the object traffic monitoring terminal.

9. The traffic monitoring terminal according to claim 1,
wherein the traffic monitoring terminal is configured to acquire an intensity of ambient light, and is further configured to adjust an exposure mode of the camera device based on the intensity of the ambient light.

10. The traffic monitoring terminal according to claim 1, wherein the traffic monitoring terminal is further configured to adjust an alternating time of traffic lights at the intersection based on the number of vehicles waiting at the intersection.

11. The traffic monitoring terminal according to claim 3, wherein the traffic monitoring terminal is further configured to adjust an alternating time of traffic lights at the intersection based on the number of pedestrians in the pedestrian waiting zone.

12. The traffic monitoring terminal according to claim 1,
wherein the traffic monitoring terminal is configured to communicate with an external device in a non-contact manner.

13. The traffic monitoring terminal according to claim 1, further comprising:
a light-emitting diode (LED) interface configured to be connected to an external LED display device.

14. The traffic monitoring terminal according to claim 1, further comprising:
a barometer configured to acquire an ambient pressure value.

15. The traffic monitoring terminal according to claim 14, wherein the traffic monitoring terminal is further configured to acquire an installation height of the traffic monitoring terminal based on the ambient pressure value.

16. The traffic monitoring terminal according to claim 14, wherein the traffic monitoring terminal is further configured to adjust an exposure mode of the camera device based on current time information.

17. A traffic monitoring system, comprising at least two traffic monitoring terminals, wherein each of the at least two traffic monitoring terminals comprises a camera device and a central processing unit (CPU), and is configured to acquire, by the camera device, a traffic image of an intersection and configured to acquire a number of vehicles waiting at the intersection based on the traffic image.

18. The traffic monitoring system according to claim 17, further comprising:
a cloud platform connected to and communicated with the at least two traffic monitoring terminals,
wherein the cloud platform is configured to acquire data from a target traffic monitoring terminal based on a target geographic location, the target traffic monitoring terminal being a traffic monitoring terminal with a distance from the target geographic location smaller than a preset distance value.

19. The traffic monitoring system according to claim 17, wherein each of the traffic monitoring terminals is configured to acquire an infrared image of a pedestrian waiting zone, and is configured to acquire a first proportion defined by a proportion of a region corresponding to a human body temperature in the infrared image to the infrared image, and to acquire a first area defined by a product of a road area corresponding to the infrared image and the first proportion.

20. The traffic monitoring system according to claim 19, wherein each of the traffic monitoring terminals is further configured to acquire a number of pedestrians in the pedestrian waiting zone based on the first area.
